(19) United States
(12) Patent Application Publication
(10) Pub. No.: US 2022/0261268 A1
(43) Pub. Date: Aug. 18, 2022

(54) CONTROL DEVICE AND CONTROL METHOD FOR VIRTUAL MACHINE SYSTEM

(71) Applicant: FUJITSU LIMITED, Kawasaki-shi (JP)

(72) Inventor: Hiroyoshi KODAMA, Isehara (JP)

(73) Assignee: FUJITSU LIMITED, Kawasaki-shi (JP)

(21) Appl. No.: 17/555,991

(22) Filed: Dec. 20, 2021

(30) Foreign Application Priority Data
Feb. 17, 2021 (JP) 2021-022942

(51) Int. Cl. G06F 9/455

(52) U.S. Cl. CPC G06F 9/45558; G06F 2009/45583

(57) ABSTRACT

An information processing system includes first and second information processing apparatuses and a control device. The control device performs control to allocate, based on memory usage information of a first virtual machine that operates in the first information processing device, a first storage device to the first information processing device and to allocate a second storage device that operates at a speed lower than a speed of the first storage device to a second information processing device in which a second virtual machine operates. The first information processing device does not include a SCM (Storage Class Memory), while the second information processing device includes a SCM.

### CROSS-REFERENCE TO RELATED APPLICATION

This application is based upon and claims the benefit of priority of the prior Japanese Patent Application No. 2021-22942, filed on Feb. 17, 2021, the entire contents of which are incorporated herein by reference.

### FIELD

The embodiment discussed herein is related to a control technique for a virtual machine system.

### BACKGROUND

In recent years, the performance of physical servers has improved due to an increase in the number of CPU cores included in a central processing unit (CPU) and the like. Accordingly, it is possible to construct many virtual servers in one physical server, and thus a service for providing those virtual servers to users has become a main cloud service. A virtual server is sometimes called a virtual machine (VM).

In relation to the virtual machine, there has been known a system for carrying out automated tiering. There has also been known a storage device capable of performing hierarchical storage control regarding file storage positions without depending on an operating system (OS) or application executed by a host computer.

Japanese Laid-open Patent Publication No. 2019-21315 and Japanese Laid-open Patent Publication No. 2006-216070 are disclosed as related art.

Advances in memory and storage device technology in recent years have been remarkable, and tiers of memory and storage devices classified by performance and a cost have increased from conventional two to three tiers to four to six tiers. Such a multi-layering tendency is expected to continue in the future.

For example, a dynamic random access memory (DRAM) is used as a memory of a physical server, and a solid state drive (SSD), a NAND flash memory, or a hard disk drive (HDD) is used as a storage device, for example. These days, there has further emerged a memory device called a storage class memory (SCM).

Various types of SCMs including a resistive random access memory (ReRAM), a magnetoresistive random access memory (MRAM), and the like have been studied and developed. A data center persistent memory (DCPM) manufactured by Intel Corporation is also a type of SCMs.

A storage capacity of the SCM is larger than that of the DRAM, and is smaller than those of the SSD, NAND flash memory, and HDD. A price per unit storage capacity of the SCM is cheaper than that of the DRAM, and is more expensive than those of the SSD, NAND flash memory, and HDD.

The DCPM is used by being inserted into a memory slot of a physical server, and operates in one of operational modes including a volatile mode and a non-volatile mode. There is no dynamic switching between the volatile mode and the non-volatile mode. The volatile mode and the non-volatile mode may also be referred to as a memory mode and an app direct mode, respectively.

### SUMMARY

According to an aspect of the embodiments, a control device for controlling an information processing system that provides multiple virtual machines, the control device including a memory, and a processor coupled to the memory. The processor is configured to obtain memory usage information of a first virtual machine that operates in a first information processing device included in the information processing system, and perform control to allocate, based on the memory usage information of the first virtual machine, a first storage device to the first information processing device and to allocate a second storage device that operates at a speed lower than a speed of the first storage device to a second information processing device in which a second virtual machine operates included in the information processing system, wherein the first information processing device includes a first memory, the first information processing device does not include a first memory device having a storage capacity larger than a storage capacity of the first memory and to be used in place of the first memory, the second information processing device includes a second memory, and the second information processing device includes a second memory device having a storage capacity larger than a storage capacity of the second memory and to be used in place of the second memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating a layered storage system;

FIG. 2 is a diagram illustrating a difference in performance of VMs;

FIG. 3 is a functional configuration diagram of a control device;

FIG. 4 is a flowchart of a control process;

FIG. 5 is a configuration diagram of an information processing system;

FIG. 6 is a functional configuration diagram of a control server;

FIG. 7 is a diagram illustrating improvement in the VM performance

FIG. 8 is a diagram illustrating performance of applications specified by a benchmark;

FIG. 9 is a diagram illustrating performance of an application that uses data of 500 GB;

FIG. 10 is a flowchart of a first control process performed by the control server;

FIG. 11 is a flowchart of a second control process performed by the control server; and

FIG. 12 is a hardware configuration diagram of an information processing device.

### DESCRIPTION OF EMBODIMENTS

In the volatile mode, the DCPM is used as a large-capacity memory in place of the DRAM installed as a memory in the physical server, and the DRAM is used as a cache of the DCPM. The access speed of the DCPM is faster than that of the SSD, and is slower than that of the DRAM.

An OS recognizes the storage capacity of the DCPM as a memory capacity, and an access to the DCPM is controlled by a memory controller. An existing OS and application programs may be used as they are without modification. Hereinafter, an application program may be simply referred to as an application.

In a case where a large-capacity DCPM is installed in a physical server, swapping to a storage device such as an HDD is less likely to occur. Furthermore, in a case where a DCPM is installed in a physical server of a virtualization platform system, it becomes possible to accommodate more VMs.

In the non-volatile mode, the DCPM is used as a large-capacity non-volatile memory or a high-speed storage device. In this case, the OS and applications are modified and used.

As described above, the DRAM and the SCM are different in performance and cost. Therefore, in an information processing system in which a physical server without an SCM and a physical server with an SCM coexist, it is preferable to place an appropriate VM depending on characteristics of the memory device installed in each physical server. In a case where VMs are not properly placed on multiple physical servers, a difference in performance between the VMs may increase.

Note that such a problem is not limited to a physical server including an SCM, and it occurs in an information processing device (computer) with a storage capacity larger than that of a memory and including various memory devices to be used in place of the memory.

In one aspect, the present embodiment aims to uniformize performance of virtual machines in an information processing system having a storage capacity larger than that of a memory and including an information processing device including a memory device to be used in place of the memory.

Hereinafter, an embodiment will be described in detail with reference to the drawings.

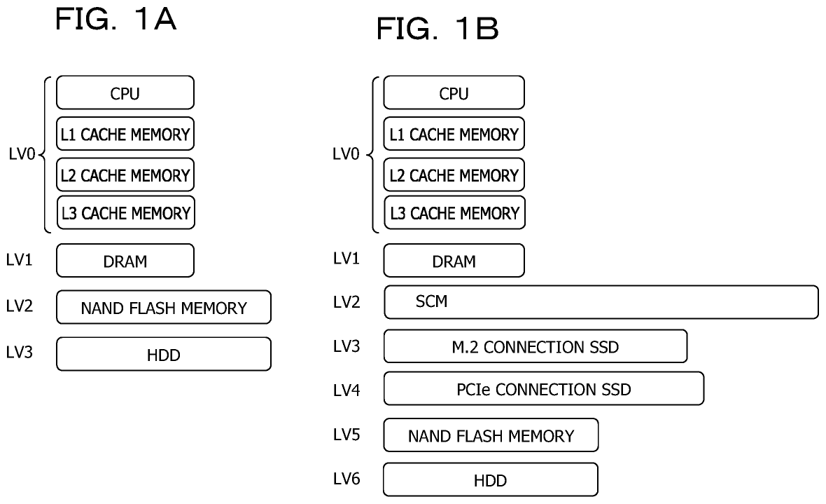

FIGS. 1A and 1B illustrate exemplary layered storage systems. FIG. 1A illustrates an example of a three-tier storage system. A level LV0 includes a CPU, a level-1 (L1) cache memory, a level-2 (L2) cache memory, and a level-3 (L3) cache memory. A level LV1 includes a DRAM, a level LV2 includes a NAND flash memory, and a level LV3 includes an HDD.

An access speed of a device increases from the level LV3 toward the level LV0, and a price of the device decreases from the level LV0 toward the level LV3.

FIG. 1B illustrates an example of a six-tier storage system. A level LV0 and a level LV1 are similar to those in FIG. 1A. A level LV2 includes an SCM, a level LV3 includes an M.2 connection SSD, and a level LV4 includes a peripheral component interconnect express (PCIe) connection SSD. A level LV5 includes a NAND flash memory, and a level LV6 includes an HDD.

The M.2 connection SSD is an SSD to be connected to an information processing device by M.2, and the PCIe connection SSD is an SSD to be connected to the information processing device by PCIe.

An access speed of a device increases from the level LV6 toward the level LV0, and a price of the device decreases from the level LV0 toward the level LV6. In the future, it is expected that the number of physical servers adopting a multi-tier storage system as illustrated in FIG. 1B will increase.

In a virtualization platform system with a multi-tier storage system, performance of a VM when accessing only a device in one tier and performance of a VM when accessing another device across the tier are significantly different. Accordingly, it is difficult for a business operator who operates the virtualization platform system to provide VMs to users to maintain the same performance of a plurality of VMs.

In a case of constructing the virtualization platform system using only devices of the same tier to reduce the difference in VM performance, it is forced to construct a large number of small virtualization platform systems. In this case, the operation cost of the business operator increases.

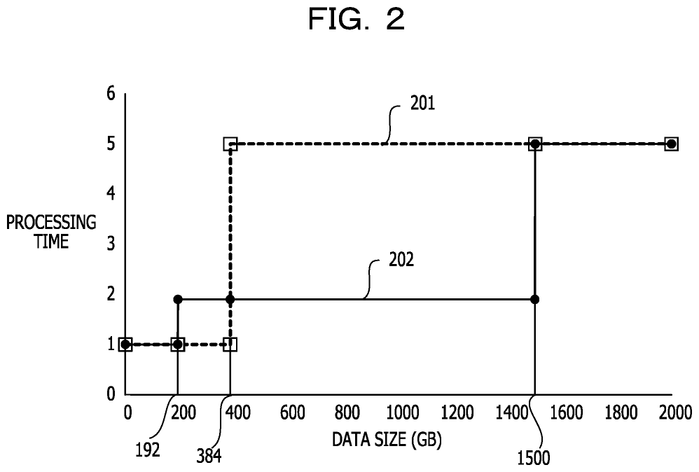

FIG. 2 illustrates an example of the difference in VM performance between two types of physical servers. The horizontal axis represents a data size of data used by the application executed by the VM, and the vertical axis represents a processing time for the application to process the data.

A broken line 201 indicates a change in the processing time in a case where the VM in a physical server S1 executes the application. The physical server S1 has the following configuration including a two-tier storage system.

Physical server S1
CPU
DRAM 384 GB (16 GB×24)
HDD
5000 VMs

A solid line 202 indicates a change in the processing time in a case where the VM in a physical server S2 executes the application. The physical server S2 has the following configuration including a five-tier storage system.

Physical server S2
CPU
DRAM 192 GB (16 GB×12)
DCPM 1.5 TB (128 GB×12)
High-speed SSD
Low-speed SSD
HDD
5000 VMs

The broken line 201 overlaps with the solid line 202 in a section where the data size is 0 to 192 GB and in a section of 1.5 TB or more. In this example, the processing time of the case where the application in the physical server S1 processes the data of 0 to 192 GB is used as a unit processing time.

For example, a case where the business operator who owns the physical server S1 has added the physical server S2 is assumed. There is no difference in the processing time between the physical server S1 and the physical server S2 in the section where the data size is 0 to 192 GB and in the section of 1.5 TB or more.

However, in a section where the data size is 192 to 384 GB, the physical server S2 accesses the DCPM slower than the DRAM, whereby the physical server S2 has a processing time longer than that of the physical server S1.

Furthermore, in a section where the data size is 384 GB to 1.5 TB, swapping occurs between a page in the DRAM and a page in the HDD in the physical server S1, whereby the physical server S1 has a processing time significantly longer than that of the physical server S2.

As described above, the performance of the VMs disposed on the physical server not including the DCPM and the physical server including the DCPM may be reversed depending on the data size. Therefore, in a case of determining a selling price of the VM on the basis of only the hardware configuration of the physical server to provide it to the user, there is a possibility that a reverse phenomenon of the performance and price may occur depending on the data size of the data to be used by the application.

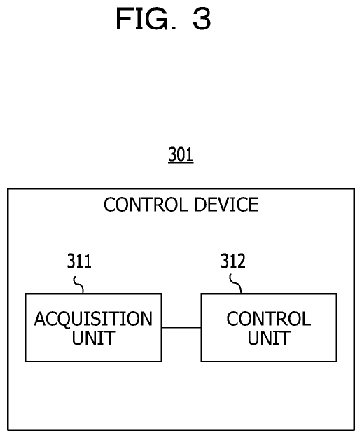

FIG. 3 illustrates an exemplary functional configuration of a control device according to an embodiment. A control device 301 of FIG. 3 includes an acquisition unit 311 and a control unit 312, and controls an information processing system including a first information processing device and a second information processing device.

The first information processing device includes a first memory. The first information processing device has a storage capacity larger than that of the first memory, and does not include a first memory device to be used in place of the first memory. The second information processing device includes a second memory. The second information processing device has a storage capacity larger than that of the second memory, and includes a second memory device to be used in place of the second memory.

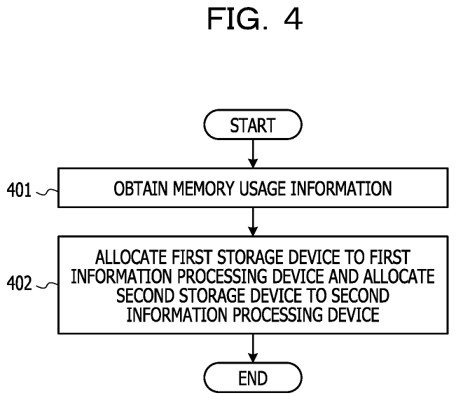

FIG. 4 is a flowchart illustrating an exemplary control process to be performed by the control device 301 of FIG. 3. First, the acquisition unit 311 obtains memory usage information of a first virtual machine operating in the first information processing device (step 401).

Next, the control unit 312 performs control to allocate, on the basis of the memory usage information of the first virtual machine, a first storage device to the first information processing device and to allocate a second storage device to the second information processing device in which a second virtual machine is operating (step 402). The second storage device is a storage device that operates at a speed lower than that of the first storage device.

According to the control device 301 of FIG. 3, it becomes possible to uniformize the VM performance in the information processing system having a storage capacity larger than that of a memory and including an information processing device including a memory device to be used in place of the memory.

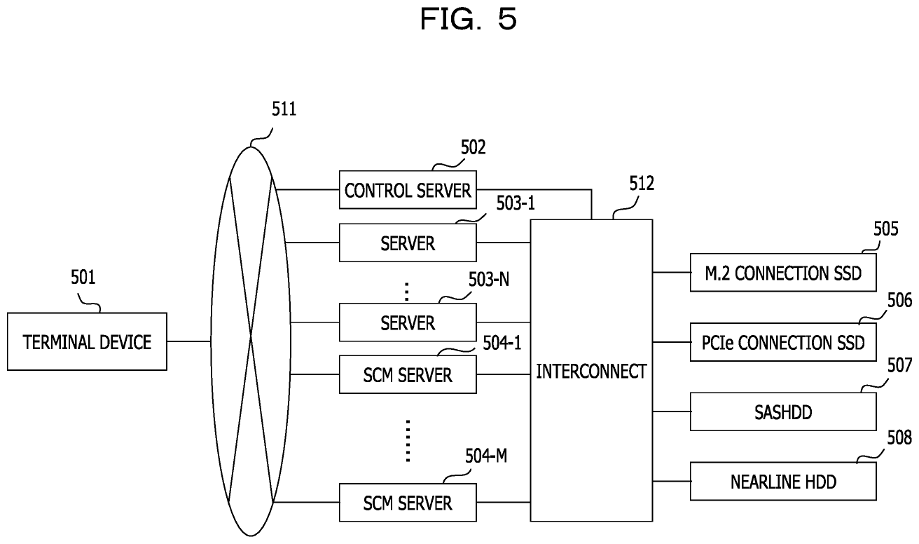

FIG. 5 illustrates an exemplary configuration of the information processing system including the control device 301 of FIG. 3. The information processing system of FIG. 5 includes a terminal device 501, a control server 502, servers 503-1 to 503-N (N is an integer of 1 or more), and SCM servers 504-1 to 504-M (M is an integer of 1 or more). The information processing system further includes an M.2 connection SSD 505, a PCIe connection SSD 506, a serial attached SCSI (SAS) HDD 507, and a nearline HDD 508.

The control server 502, a server 503-i (i=1 to N), and an SCM server 504-j (j=1 to M) are physical servers. The server 503-i is a physical server that does not include an SCM, and the SCM server 504-j is a physical server that includes an SCM. The control server 502 corresponds to the control device 301 of FIG. 3, and the server 503-i and the SCM server 504-j correspond to the first information processing device and the second information processing device, respectively.

The terminal device 501, the control server 502, the server 503-i, and the SCM server 504-j are capable of communicating with each other via a communication network 511. The communication network 511 is, for example, a wide area network (WAN).

The M.2 connection SSD 505, the PCIe connection SSD 506, the SAS HDD 507, and the nearline HDD 508 are exemplary storage devices. Those storage devices are connected to either any server 503-i or any SCM server 504-j via an interconnect 512.

The access speed of the SAS HDD 507 is faster than that of the nearline HDD 508, and the access speed of the PCIe connection SSD 506 is faster than that of the SAS HDD 507. The access speed of the M.2 connection SSD 505 is faster than that of the PCIe connection SSD 506. Therefore, in the information processing system of FIG. 5, the fastest storage device is the M.2 connection SSD 505, and the slowest storage device is the nearline HDD 508.

The information processing system of FIG. 5 is a virtualization platform system that provides a cloud service. The control server 502, the server 503-i, and the SCM server 504-j are information processing devices of a cloud service provider, and the terminal device 501 is an information processing device of a user who uses the cloud service.

In response to a construction request from the terminal device 501, the control server 502 constructs a plurality of VMs in the server 503-i or the SCM server 504-j, and provides them to the terminal device 501. For example, several tens to thousands of VMs are constructed.

The server 503-i has the following configuration including a one-tier storage system, for example.

Server 503-i
CPU
DRAM 384 GB

The CPU of the server 503-i generates a VM using a DRAM, and causes the generated VM to run the application. Meanwhile, the SCM server 504-j has the following configuration including a two-tier storage system, for example.

SCM server 504-j
CPU
DRAM 192 GB
DCPM 1.5 TB

The DCPM has a storage capacity larger than that of the DRAM, and is used in place of the DRAM. As a result, the storage capacity of the DRAM is expanded. The OS recognizes the storage capacity of the DCPM as a memory capacity, and recognizes the usage of the DCPM as a memory usage. The DRAM is used as a cache for the DCPM. Other SCMs such as the ReRAM or the MRAM may be used in place of the DCPM.

The CPU of the SCM server 504-j generates a VM using the DCPM, and causes the generated VM to run the application. The configuration of the server 503-i corresponds to the configuration of the physical server S1 excluding the HDD, and the configuration of the SCM server 504-j corresponds to the configuration of the physical server S2 excluding the high-speed SSD, the low-speed SSD, and the HDD.

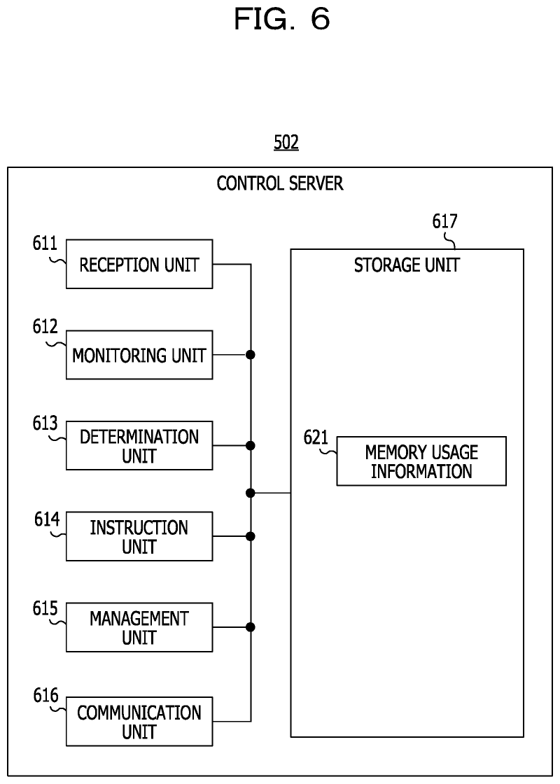

FIG. 6 illustrates an exemplary functional configuration of the control server 502 of FIG. 5. The control server 502 of FIG. 6 includes a reception unit 611, a monitoring unit 612, a determination unit 613, an instruction unit 614, a management unit 615, a communication unit 616, and a storage unit 617. The monitoring unit 612 corresponds to the acquisition unit 311 of FIG. 3, and the determination unit 613 and the instruction unit 614 correspond to the control unit 312.

The communication unit 616 communicates with the terminal device 501, the server 503-i, and the SCM server 504-j via the communication network 511. The terminal device 501 transmits a construction request for constructing one or a plurality of VMs to the control server 502 on the basis of an instruction from the user, and the communication unit 616 receives the construction request.

The reception unit 611 accepts the received construction request, and transfers it to the instruction unit 614. The instruction unit 614 selects a server on which each VM indicated by the construction request is placed from among the servers 503-1 to 503-N and the SCM servers 504-1 to 504-M. Then, the instruction unit 614 instructs the management unit 615 to place each VM on the selected server.

The management unit 615 has a function of managing a virtualization platform, and requests generation of the VM instructed by the instruction unit 614 to the instructed server via the communication unit 616. The server that has received the request from the management unit 615 generates the requested VM. As a result, one or a plurality of VMs indicated by the construction request are constructed in the information processing system. The user logs in to each of the constructed VMs using the terminal device 501 to cause each VM to run the application.

The monitoring unit 612 monitors the memory usage status of each VM operating in the respective servers 503-i and the respective SCM servers 504-j, and stores information indicating the memory usage status of each VM in the storage unit 617 as memory usage information 621. The information indicating the memory usage status includes memory usage and memory shortage occurrence recognized by the OS.

The memory usage of the VM indicates the size of the storage area used in the DRAM of the server 503-i or in the DCPM of the SCM server 504-j. The memory usage may be a ratio of the used storage area to the storage capacity of the DRAM or DCPM.

In a case where data volume of data used by the VM is larger than the storage capacity of the DRAM or DCPM and the storage capacity is insufficient, the OS performs swapping between a page in the DRAM or DCPM and a page in the storage device. At this time, the OS generates a swap area in the storage device connected to the server 503-i or to the SCM server 504-j.

Accordingly, the monitoring unit 612 detects the processing in which the OS generates a swap area in the storage device as occurrence of a memory shortage. The occurrence of a memory shortage indicates that the data volume of data used by the VM has become larger than the storage capacity of the DRAM or DCPM.

The determination unit 613 determines that the allocation of the storage device is to be changed in a case where the memory usage information 621 of the VM operating in the server 503-i indicates the memory shortage occurrence. Then, the determination unit 613 allocates the M.2 connection SSD 505, which is the fastest storage device, to the server 503-i, and allocates the second fastest PCIe connection SSD 506 to the SCM server 504-j.

The instruction unit 614 instructs the interconnect 512 to allocate the M.2 connection SSD 505 to the server 503-i and to allocate the PCIe connection SSD 506 to the SCM server 504-j. The interconnect 512 connects the M.2 connection SSD 505 to the server 503-i, and connects the PCIe connection SSD 506 to the SCM server 504-j in accordance with the instruction from the instruction unit 614.

In this manner, among the plurality of storage devices, the M.2 connection SSD 505 having the access speed closest to that of the DRAM is allocated to the server 503-i on which the VM in which the memory shortage has occurred is operating. Then, among the remaining storage devices, the PCIe connection SSD 506 having the access speed closest to that of the DCPM is allocated to the SCM server 504-j.

Accordingly, the extreme degradation in performance of the VM in which the memory shortage has occurred is suppressed, and the difference between the access speed in a case where the swap has occurred in the DRAM of the server 503-i and the access speed in a case where the swap has occurred in the DCPM of the SCM server 504-j is reduced. As a result, the performance of the VM in the server 503-i and the performance of the VM in the SCM server 504-j are made uniform.

In a case where the M.2 connection SSD 505 is not allocatable, the second fastest PCIe connection SSD 506 is allocated to the server 503-i. Then, the SAS HDD 507, which is slower than the PCIe connection SSD 506, is allocated to the SCM server 504-j.

In a case where the PCIe connection SSD 506 is also not allocatable, the third fastest SAS HDD 507 is allocated to the server 503-i. Then, the nearline HDD 508, which is slower than the SAS HDD 507, is allocated to the SCM server 504-j.

Meanwhile, in a case where the memory usage of the VM operating in the SCM server 504-j exceeds the storage capacity of the DRAM in the SCM server 504-j, the data to be used fails to be stored in the DRAM serving as a cache. Accordingly, access to the DCPM with the slower access speed occurs, thereby degrading the VM performance.

In view of the above, the determination unit 613 compares the memory usage indicated by the memory usage information 621 of the VM operating in the SCM server 504-j with the storage capacity of the DRAM of the SCM server 504-j and server 503-i. In a case where the memory usage of the VM is larger than the storage capacity of the DRAM of the SCM server 504-j and is smaller than the storage capacity of the DRAM of the server 503-i, the determination unit 613 determines the VM as a VM to be moved.

The instruction unit 614 instructs the management unit 615 to perform migration for moving the VM to be moved from the SCM server 504-j in which the VM to be moved is operating to any of the servers 503-i.

The management unit 615 requests the SCM server 504-j on which the VM to be moved is operating to migrate the VM to be moved instructed by the instruction unit 614 via the communication unit 616. The SCM server 504-j that has received the request from the management unit 615 moves the VM to be moved to the instructed server 503-i.

Since the access speed of the DRAM of the server 503-i is faster than that of the DCPM, the VM performance is improved by the VM moved to the server 503-i in a case where the memory usage is smaller than the storage capacity of the DRAM. As a result, it becomes possible to bring the VM performance in which the performance is degraded close to the performance of other VMs, thereby uniformizing the VM performance.

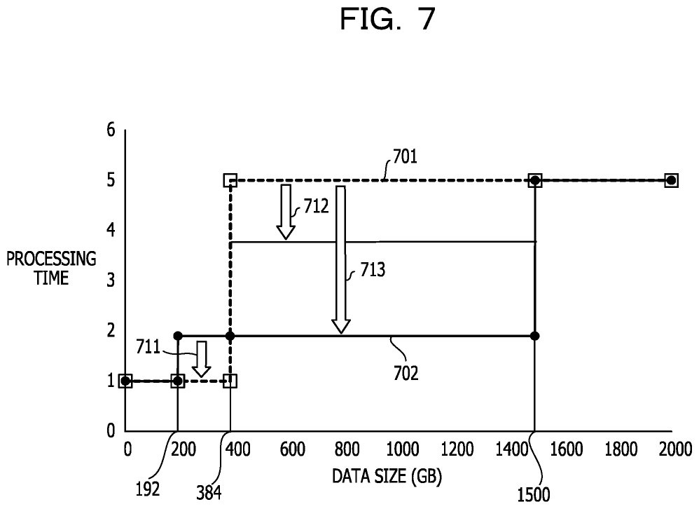

FIG. 7 illustrates exemplary improvement in the performance of the VMs operating in the server 503-i and SCM server 504-j. The horizontal axis represents a data size of data used by the application executed by the VM, and the vertical axis represents a processing time for the application to process the data.

A broken line 701 indicates a change in the processing time in a case where the VM in the server 503-i executes the application, and a solid line 702 indicates a change in the processing time in a case where the VM in the SCM server 504-j executes the application. The changes in the processing time indicated by the broken line 701 and the solid line 702 are similar to the changes in the processing time indicated by the broken line 201 and the solid line 202 illustrated in FIG. 2.

A case where, in a section where the data size is 192 to 384 GB, the memory usage of the VM operating in the SCM server 504-j is larger than the storage capacity of the DRAM of the SCM server 504-j and is smaller than the storage capacity of the DRAM of the server 503-i is assumed. In this case, with the VM moved from the SCM server 504-j to the server 503-i, it becomes possible to shorten the processing time as indicated by an arrow 711.

Next, a case where, in a section where the data size is 384 GB to 1.5 TB, a memory shortage of the VM operating in the server 503-i has occurred is assumed. In this case, with a high-speed storage device allocated to the server 503-i, it becomes possible to shorten the processing time to bring it close to the processing time of the SCM server 504-j as indicated by an arrow 712.

Furthermore, with the VM moved from the server 503-i to the SCM server 504-j instead of changing the allocation of the storage device, it becomes possible to significantly shorten the processing time as indicated by an arrow 713.

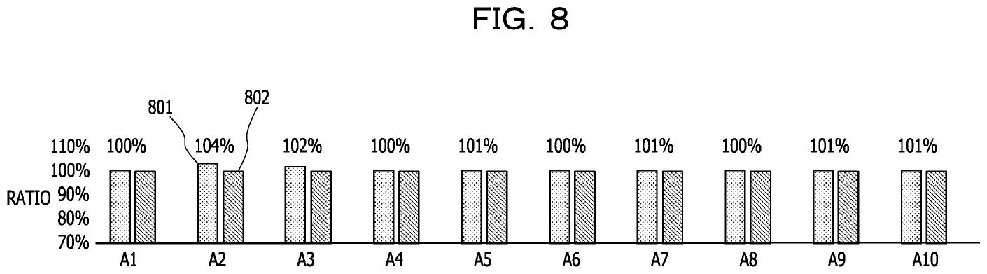

FIG. 8 illustrates exemplary performance of applications specified by the SPEC CPU (registered trademark) 2017 benchmark.

A1 to A10 indicate the following integer arithmetic applications.
A1 500.perlbench_r
A2 502.gcc_r
A3 505.mcf_r
A4 520.omnetpp_r
A5 523.xalancbmk_r
A6 525.x264_r
A7 531.deepsjeng_r
A8 541.leela_r
A9 548.exchange2_r
A10 557.xz_r

A vertical bar 801 of the application A1 indicates a ratio R1 of a processing time T2 in a case where the VM in the SCM server 504-j runs the application A1 to a processing time T1 in a case where the VM in the server 503-i runs the application A1. A vertical bar 802 indicates a ratio R2 (100%) of the processing time T1 to the processing time T1 for comparison.

Vertical bars of the applications A2 to A10 are similar to those of the case of the application A1. While the ratio R1 changes depending on the application, the ratio R2 is 100% for all the applications.

The data size of the data used by each application is 16 GB, which corresponds to the section of 0 to 192 GB in FIG. 7. Since 16 GB is smaller than the storage capacity of the DRAM of the SCM server 504-j, the processing time of each application differs little between the server 503-i and the SCM server 504-j.

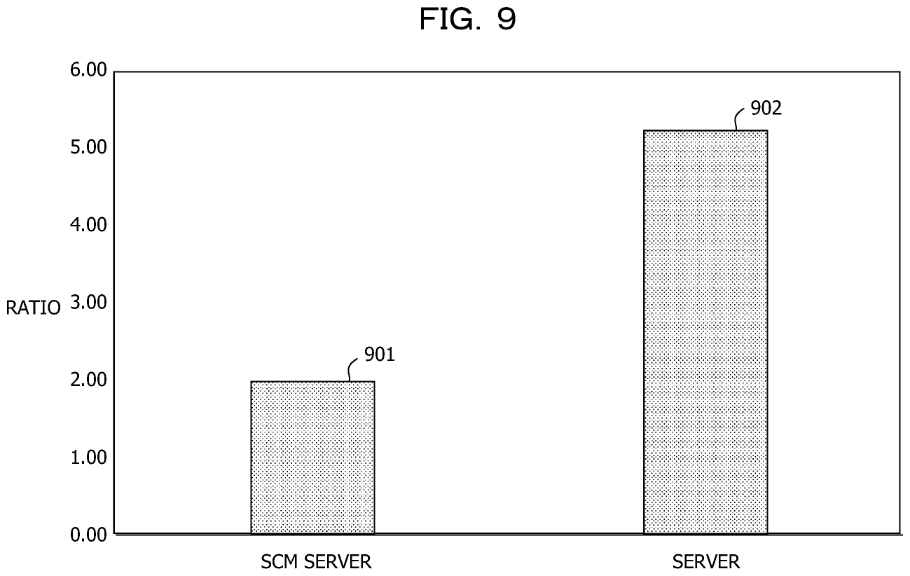

FIG. 9 illustrates exemplary performance of an application that uses data of 500 GB. A vertical bar 901 indicates a ratio of a processing time in a case where the VM in the SCM server 504-j runs a predetermined application AP to a processing time in a case where the VM in a virtual physical server SS to be described later runs the application AP. In this case, the application AP performs processing using the data of 500 GB corresponding to the section of 384 GB to 1.5 TB in FIG. 7.

A vertical bar 902 indicates a ratio of a processing time in a case where the VM in the server 503-i runs the application AP to a processing time in a case where the VM in the physical server SS runs the application AP.

The physical server SS is a physical server that includes a DRAM of 768 GB and does not include a DCPM. In a case where the VM in the physical server SS runs the application AP that uses data of 500 GB, all the data are stored in the DRAM, whereby it is possible to run the application AP in a short time.

Meanwhile, when the VM in the server 503-i runs the application AP, the data size exceeds 384 GB, which is the storage capacity of the DRAM, and thus a swap occurs between the DRAM and the storage device. Therefore, as indicated by the vertical bar 902, the processing time of the server 503-i is 5.2 times longer than the processing time of the physical server SS.

On the other hand, when the VM in the SCM server 504-j runs the application AP, the data size is smaller than 1.5 TB, which is the storage capacity of the DCPM, and thus no swap occurs between the DCPM and the storage device. Therefore, as indicated by the vertical bar 901, the processing time of the SCM server 504-j is only 1.95 times longer than the processing time of the physical server SS, which is considerably shorter than the processing time of the server 503-i.

As described above, since the difference in performance between the server 503-i and the SCM server 504-j is large in the section where the data size is 384 GB to 1.5 TB, as illustrated in FIG. 7, it is effective to change the allocation of the storage device or to migrate the VM.

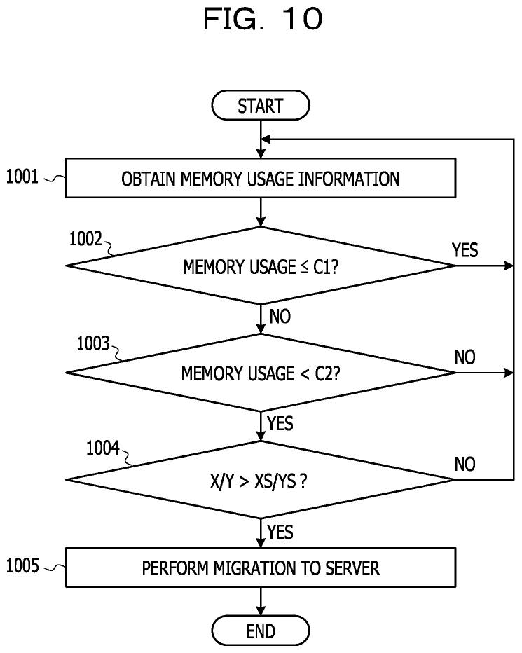

FIG. 10 is a flowchart illustrating an example of a first control process to be performed by the control server 502 of FIG. 6. In the control process of FIG. 10, it is determined whether or not to migrate the VM operating in the SCM server 504-j.

A cost X in step 1004 represents a cost per VM in the SCM server 504-j, and a cost Y represents a cost per VM in the server 503-i. The cost per VM is indicated by, for example, a selling price per VM presented to the user.

Performance XS represents operating performance of the VM in the SCM server 504-j, and performance YS represents operating performance of the VM in the server 503-i. The operating performance of the VM is indicated by, for example, a reciprocal of a processing time in a case where the VM runs a predetermined application. The cost X, the cost Y, the performance XS, and the performance YS are setting values set in advance.

First, the monitoring unit 612 obtains the memory usage information 621 of each VM operating in the respective SCM servers 504-j (step 1001). Then, the determination unit 613 compares the memory usage indicated by the memory usage information 621 with a storage capacity C1 of the DRAM of the SCM server 504-j (step 1002). If the memory usage is equal to or less than the storage capacity C1 of the DRAM (YES in step 1002), the control server 502 repeats the processing of step 1001 and subsequent steps.

On the other hand, if the memory usage is larger than the storage capacity C1 of the DRAM (NO in step 1002), the determination unit 613 compares the memory usage indicated by the memory usage information 621 with a storage capacity C2 of the DRAM of the server 503-i (step 1003). If the memory usage is equal to or larger than the storage capacity C2 of the DRAM (NO in step 1003), the control server 502 repeats the processing of step 1001 and subsequent steps.

On the other hand, if the memory usage is smaller than the storage capacity C2 of the DRAM (YES in step 1003), the determination unit 613 compares X/Y with XS/YS to determine whether or not to perform VM migration (step 1004). If X/Y is equal to or smaller than XS/YS (NO in step 1004), the control server 502 repeats the processing of step 1001 and subsequent steps without performing VM migration.

On the other hand, if X/Y is larger than XS/YS (YES in step 1004), the determination unit 613 determines the VM corresponding to the obtained memory usage information 621 as a VM to be moved. Then, the instruction unit 614 instructs the management unit 615 to perform migration for moving the determined VM to be moved to any server 503-i (step 1005).

The management unit 615 requests the migration of the VM to be moved to the SCM server 504-j on which the VM to be moved is operating, and the SCM server 504-j moves the VM to be moved to the server 503-i.

If the memory usage is larger than the storage capacity C1 and is smaller than the storage capacity C2, the VM is moved to the server 503-i, whereby it becomes possible to shorten the processing time of the VM as indicated by the arrow 711 in FIG. 7.

X/Y indicates a ratio of the cost of the VM in the SCM server 504-j to the cost of the VM in the server 503-i, and XS/YS indicates a ratio of the performance of the VM in the SCM server 504-j to the performance of the VM in the server 503-i. Therefore, in a case where X/Y is larger than XS/YS, the performance ratio is smaller than the cost ratio, and the performance per unit price of the VM in the SCM server 504-j is smaller than the performance per unit price of the VM in the server 503-i.

In this case, with the VM in the SCM server 504-j moved to the server 503-i, it becomes possible to improve the performance of the VM per unit cost.

Note that, in a case where the performance of the VM per unit cost does not need to be considered, the control server 502 may omit the processing of step 1004 and perform the processing of step 1005.

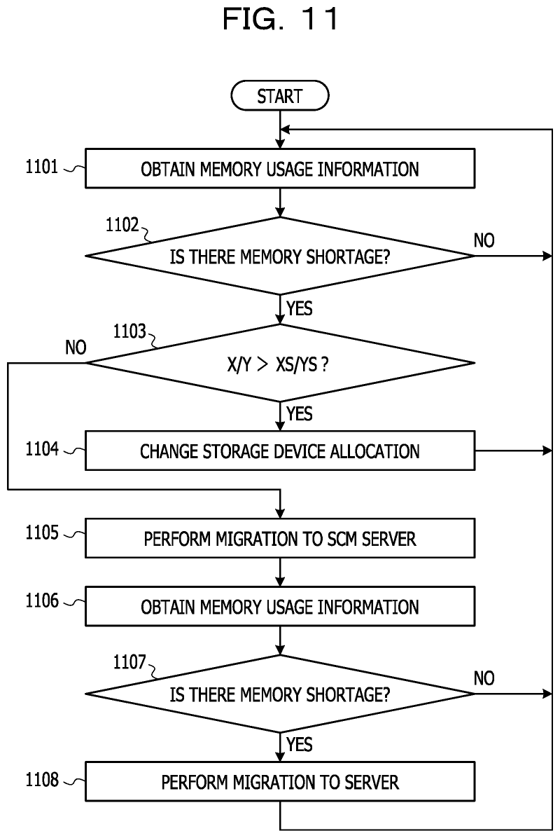

FIG. 11 is a flowchart illustrating an example of a second control process to be performed by the control server 502 of FIG. 6. In the control process of FIG. 11, it is determined whether or not to perform an allocation change of the storage device or migration on the VM operating in the server 503-i.

First, the monitoring unit 612 obtains the memory usage information 621 of each VM operating in the respective servers 503-i (step 1101). Then, the determination unit 613 checks whether or not the memory usage information 621 indicates occurrence of memory shortage (step 1102). If the memory usage information 621 does not indicate the occurrence of a memory shortage (NO in step 1102), the control server 502 repeats the processing of step 1101 and subsequent steps.

On the other hand, if the memory usage information 621 indicates the occurrence of a memory shortage (YES in step 1102), the determination unit 613 compares X/Y with XS/YS to determine whether or not to perform VM migration (step 1103).

If X/Y is larger than XS/YS (YES in step 1103), the determination unit 613 determines to change the storage device allocation instead of migrating the VM (step 1104). Then, for example, the determination unit 613 allocates the M.2 connection SSD 505 to the server 503-i on which the VM is operating, and allocates the PCIe connection SSD 506 to the SCM server 504-j.

The instruction unit 614 instructs the interconnect 512 to change the storage device allocation, and the interconnect 512 connects the M.2 connection SSD 505 to the server 503-i, and connects the PCIe connection SSD 506 to the SCM server 504-j. Then, the control server 502 repeats the processing of step 1101 and subsequent steps.

If X/Y is equal to or smaller than XS/YS (NO in step 1103), the determination unit 613 determines the VM corresponding to the obtained memory usage information 621 as a VM to be moved. Then, the instruction unit 614 instructs the management unit 615 to perform migration for moving the determined VM to be moved to any SCM server 504-j (step 1105).

The management unit 615 requests the migration of the VM to be moved to the server 503-i on which the VM to be moved is operating, and the server 503-i moves the VM to be moved to the SCM server 504-j.

Next, the monitoring unit 612 obtains the memory usage information 621 of the VM moved to the SCM server 504-j (step 1106). Then, the determination unit 613 checks whether or not the memory usage information 621 indicates occurrence of a memory shortage (step 1107). If the memory usage information 621 does not indicate the occurrence of a memory shortage (NO in step 1107), the control server 502 repeats the processing of step 1101 and subsequent steps.

On the other hand, if the memory usage information 621 indicates the occurrence of a memory shortage (YES in step 1107), the determination unit 613 determines the VM as a VM to be moved. Then, the instruction unit 614 instructs the management unit 615 to perform migration for moving the determined VM to be moved to any server 503-i (step 1108).

The management unit 615 requests the migration of the VM to be moved to the SCM server 504-j on which the VM to be moved is operating, and the SCM server 504-j moves the VM to be moved to the server 503-i. Then, the control server 502 repeats the processing of step 1101 and subsequent steps.

The storage device allocation is changed in a case where the memory shortage has occurred in step 1102, whereby it becomes possible to shorten the processing time of the VM to bring it close to the processing time of the SCM server 504-j, as indicated by the arrow 712 in FIG. 7.

In a case where X/Y is larger than XS/YS, the performance per unit price of the VM in the SCM server 504-j is smaller than the performance per unit price of the VM in the server 503-i. In this case, with the storage device allocation changed without performing VM migration, it becomes possible to suppress the cost and to shorten the processing time of the VM.

On the other hand, in a case where X/Y is equal to or smaller than XS/YS, the performance per unit price of the VM in the SCM server 504-j is equal to or higher than the performance per unit price of the VM in the server 503-i. In this case, with the VM in the server 503-i moved to the SCM server 504-j, it becomes possible to improve the performance of the VM per unit cost.

Note that, in a case where the performance of the VM per unit cost does not need to be considered, the control server 502 may omit the processing of step 1103 and perform the processing of step 1104 or the processing of step 1105 and subsequent steps.

The VM in the SCM server 504-j is moved to the server 503-i in a case where the memory shortage has occurred in step 1107, whereby it becomes possible to reduce the cost of the VM without increasing the processing time.

The configuration of the control device 301 of FIG. 3 is merely an example, and some constituent elements may be omitted or modified depending on the use or conditions of the control device 301.

The configuration of the information processing system of FIG. 5 is merely an example, and some constituent elements may be omitted or modified depending on the use or conditions of the information processing system. For example, a storage device other than the M.2 connection SSD 505, the PCIe connection SSD 506, the SAS HDD 507, and the nearline HDD 508 may be connected to the server 503-i and to the SCM server 504-j. The information processing system may include five or more storage devices.

The configuration of the control server 502 of FIG. 6 is merely an example, and some constituent elements may be omitted or modified depending on the use or conditions of the information processing system. For example, the management unit 615 of FIG. 6 may be provided in an external device of the control server 502. In this case, the instruction unit 614 instructs the management unit 615 to perform migration of the VM to be moved via the communication unit 616.

The flowcharts of FIGS. 4, 10, and 11 are merely examples, and some processes may be omitted or modified depending on the configuration or conditions of the control device 301 or the information processing system. For example, in a case where the performance of the VM per unit cost does not need to be considered, the processing of step 1004 in FIG. 10 and the processing of step 1103 in FIG. 11 may be omitted.

The storage system illustrated in FIGS. 1A and 1B is merely an example, and the layered storage system includes a storage system having a different configuration. The changes in the processing time illustrated in FIGS. 2 and 7 are merely examples, and the processing time changes depending on the configuration of the physical server and the application. The performance of the application illustrated in FIGS. 8 and 9 is merely an example, and the performance of the application changes depending on the configuration of the physical server and the application.

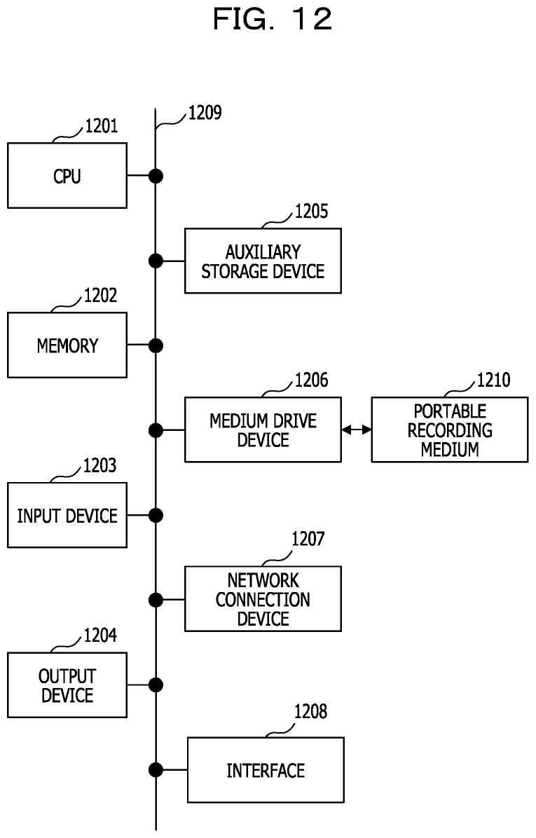

FIG. 12 illustrates an exemplary hardware configuration of the information processing device to be used as the control device 301 of FIG. 3 and the control server 502 of FIG. 6. The information processing device of FIG. 12 includes a CPU 1201, a memory 1202, an input device 1203, an output device 1204, an auxiliary storage device 1205, a medium drive device 1206, a network connection device 1207, and an interface 1208. These constituent elements are hardware, and are connected to each other by a bus 1209.

The memory 1202 is, for example, a semiconductor memory such as a read only memory (ROM) or a random access memory (RAM), and stores programs and data to be used for processing. The memory 1202 may operate as the storage unit 617 in FIG. 6.

The CPU 1201 executes a program using the memory 1202 to operate as the acquisition unit 311 and the control unit 312 in FIG. 3, for example. The CPU 1201 executes a program using the memory 1202 to operate also as the reception unit 611, the monitoring unit 612, the determination unit 613, the instruction unit 614, and the management unit 615 in FIG. 6.

The input device 1203 is, for example, a keyboard, a pointing device, or the like, and is used for inputting an instruction or information from an operator. The output device 1204 is, for example, a display device, a printer, or the like, and is used for an inquiry or instruction to the operator and for outputting a processing result.

The auxiliary storage device 1205 is, for example, a magnetic disk device, an optical disk device, a magneto-optical disk device, a tape device, or the like. The auxiliary storage device 1205 may be an HDD. The information processing device is capable of saving programs and data in the auxiliary storage device 1205 and loading them into the memory 1202 to use them. The auxiliary storage device 1205 may operate as the storage unit 617 in FIG. 6.

The medium drive device 1206 drives a portable recording medium 1210, and accesses recorded content thereof. The portable recording medium 1210 is a memory device, a flexible disk, an optical disk, a magneto-optical disk, or the like. The portable recording medium 1210 may be a compact disk read only memory (CD-ROM), a digital versatile disk (DVD), a universal serial bus (USB) memory, or the like.

The operator is allowed to store the programs and data in the portable recording medium 1210 to use them by loading them into the memory 1202.

As described above, the computer-readable recording medium in which the programs and data used for processing are stored includes a physical (non-transitory) recording medium such as the memory 1202, the auxiliary storage device 1205, and the portable recording medium 1210.

The network connection device 1207 is a communication interface circuit that is connected to the communication network 511 and performs data conversion associated with communication. The information processing device is capable of receiving programs and data from an external device via the network connection device 1207 and loading them into the memory 1202 to use them. The network connection device 1207 may operate as the communication unit 616 in FIG. 6.

The interface 1208 is a circuit that is connected to the interconnect 512 and transmits control signals to the interconnect 512. The CPU 1201 instructs the interconnect 512 to change the storage device allocation via the interface 1208.

An information processing device similar to that of FIG. 12 is used as the terminal device 501 of FIG. 5. Note that the information processing device does not need to include all the configuration elements in FIG. 12, and some configuration elements may be omitted depending on the use or conditions of the information processing device. For example, in a case where an interface with the operator is not needed, the input device 1203 and the output device 1204 may be omitted. In a case of not using the portable recording medium 1210, the medium drive device 1206 may be omitted.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control device for controlling an information processing system that provides multiple virtual machines, the control device comprising:
a memory, and
a processor coupled to the memory and configured to:
obtain memory usage information of a first virtual machine that operates in a first information processing device included in the information processing system; and
perform control to allocate, based on the memory usage information of the first virtual machine, a first storage device to the first information processing device and to allocate a second storage device that operates at a speed lower than a speed of the first storage device to a second information processing device in which a second virtual machine operates included in the information processing system, wherein
the first information processing device includes a first memory,
the first information processing device does not include a first memory device having a storage capacity larger than a storage capacity of the first memory and to be used in place of the first memory,
the second information processing device includes a second memory, and
the second information processing device includes a second memory device having a storage capacity larger than a storage capacity of the second memory and to be used in place of the second memory.

2. The control device according to claim 1, wherein
the perform control includes performing control to allocate the first storage device to the first information processing device and to allocate the second storage device to the second information processing device in a case where the memory usage information of the first virtual machine indicates data volume of data used by the first virtual machine is larger than the storage capacity of the first memory.

3. The control device according to claim 1, wherein
the perform control includes:
determine whether or not to move the first virtual machine to the second information processing device using a cost of the first virtual machine, a cost of the second virtual machine, operating performance of the first virtual machine and operating performance of the second virtual machine, in a case where the memory usage information of the first virtual machine indicates data volume of data used by the first virtual machine is larger than the storage capacity of the first memory;
perform control to move the first virtual machine to the second information processing device in a case where the first virtual machine is determined to move to the second information processing device; and
perform control to allocate the first storage device to the first information processing device and to allocate the second storage device to the second information processing device in a case where the first virtual machine is determined not to move to the second information processing device.

4. The control device according to claim 1, the processor is further configured to:
obtain memory usage information of the second virtual machine; and
perform control to move the second virtual machine to the first information processing device in a case where memory usage indicated by the memory usage information of the second virtual machine is larger than the storage capacity of the second memory and is smaller than the storage capacity of the first memory.

5. The control device according to claim 1, the processor is further configured to:
obtain memory usage information of the second virtual machine;
determine whether or not to move the second virtual machine to the first information processing device using a cost of the first virtual machine, a cost of the second virtual machine, operating performance of the first virtual machine and operating performance of the second virtual machine, in a case where memory usage indicated by the memory usage information of the second virtual machine is larger than the storage capacity of the second memory and is smaller than the storage capacity of the first memory; and
perform control to move the second virtual machine to the first information processing device in a case where the second virtual machine is determined to move to the first information processing device.

6. A method for controlling an information processing system that provides multiple virtual machines, the method causing a computer to execute a process comprising:
obtaining memory usage information of a first virtual machine that operates in a first information processing device included in the information processing system; and
performing control to allocate, based on the memory usage information of the first virtual machine, a first storage device to the first information processing device and to allocate a second storage device that operates at a speed lower than a speed of the first storage device to a second information processing device in which a second virtual machine operates included in the information processing system, wherein
the first information processing device includes a first memory,
the first information processing device does not include a first memory device having a storage capacity larger than a storage capacity of the first memory and to be used in place of the first memory,
the second information processing device includes a second memory, and
the second information processing device includes a second memory device having a storage capacity larger than a storage capacity of the second memory and to be used in place of the second memory.

7. The method according to claim 6, wherein
the performing control includes performing control to allocate the first storage device to the first information processing device and to allocate the second storage device to the second information processing device in a case where the memory usage information of the first virtual machine indicates data volume of data used by the first virtual machine is larger than the storage capacity of the first memory.

8. The method according to claim 6, wherein
the performing control includes:
determining whether or not to move the first virtual machine to the second information processing device using a cost of the first virtual machine, a cost of the second virtual machine, operating performance of the first virtual machine and operating performance of the second virtual machine, in a case where the memory usage information of the first virtual machine indicates data volume of data used by the first virtual machine is larger than the storage capacity of the first memory;
performing control to move the first virtual machine to the second information processing device in a case where the first virtual machine is determined to move to the second information processing device; and
performing control to allocate the first storage device to the first information processing device and to allocate the second storage device to the second information processing device in a case where the first virtual machine is determined not to move to the second information processing device.

9. The method according to claim 6, the method causing the computer to execute the process further comprising:
obtaining memory usage information of the second virtual machine; and
performing control to move the second virtual machine to the first information processing device in a case where memory usage indicated by the memory usage information of the second virtual machine is larger than the storage capacity of the second memory and is smaller than the storage capacity of the first memory.

10. The method according to claim 6, the method causing the computer to execute the process further comprising:
obtaining memory usage information of the second virtual machine;
determining whether or not to move the second virtual machine to the first information processing device using a cost of the first virtual machine, a cost of the second virtual machine, operating performance of the first virtual machine and operating performance of the second virtual machine, in a case where memory usage indicated by the memory usage information of the second virtual machine is larger than the storage capacity of the second memory and is smaller than the storage capacity of the first memory; and
performing control to move the second virtual machine to the first information processing device in a case where the second virtual machine is determined to move to the first information processing device.
